(19) United States
(12) Patent Application Publication
(10) Pub. No.: US 2006/0055792 A1
(43) Pub. Date: Mar. 16, 2006

(54) Imaging system with tracking function

(76) Inventors: Rieko Otsuka, Fuchu (JP); Takeshi Hoshino, Kodaira (JP); Youich Horii, Mitaka (JP); Shigeki Nagaya, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/072,308

(22) Filed: Mar. 7, 2005

(30) Foreign Application Priority Data
Sep. 15, 2004 (JP) 2004-267680

(51) Int. Cl. H04N 5/232

(52) U.S. Cl. 348/211.4

(57) ABSTRACT

In an imaging system that can take a picture of an object to be captured in a plurality of directions at the same time, and automatically track the object even if the object moves around, the imaging devices are moved in association with each other. An imaging system has an area in which an object being captured is placed, a plurality of imaging devices, or cameras for captured different sides of the object, the imaging devices, or cameras being connected together through a communication path to take a picture of the sides of the object from a plurality of directions, and control means provided so that, when one of the cameras tracks the object, the remaining cameras can be controlled to automatically change their pan, tilt and focus settings and track the object.

### INCORPORATION BY REFERENCE

The present application claims priority from Japanese application JP 2004-267680 filed on Sep. 15, 2004, the content of which is hereby incorporated by reference into this application.

### BACKGROUND OF THE INVENTION

The present invention relates to an imaging system capable of capturing pictures of an object simultaneously from a plurality of directions, automatically tracking the object if it is moving around, and also transmitting the captured images to a specially designed display apparatus to reproduce the image so that the object can be seen from any direction.

A document of JP-A-2004-040514 (patent document 1) discloses an imaging apparatus having object image capturing means such as means for image recognition provided to recognize an object and in which the pan/tilt mechanism and focus mechanism can be driven to bring the image of the object to the center of the screen.

In the technique described in the above patent document 1, a single imaging device is controlled, but the control among a plurality of imaging devices is not included. In order that an object to be captured can be tracked from a plurality of directions at a time, it is necessary for the imaging devices to be connected and to be controlled to cooperate with each other.

### SUMMARY OF THE INVENTION

In view of the above problems, the present invention is to provide an automatic-tracking/imaging system and method for easily and precisely imaging an object from a plurality of directions at a time.

It is another objective of the invention to provide an imaging system capable of semi-automatically tracking the moving object, imaging it from a plurality of directions at a time and transmitting the captured images in real time to an exclusive 3-dimensional display apparatus.

In order to achieve the above objectives, according to the invention there is provided an imaging system having an area in which an object whose image is to be captured is placed, and a plurality of imaging devices for picking up the different sides of the object, these imaging devices being arranged to capture the sides of the object from a plurality of directions.

In addition, according to the invention, there is provided an imaging system having a plurality of cameras arranged in a ring shape, and control means for controlling so that, when one of the cameras tracks an object that is moving around within the area surrounded by the cameras, the control means can control the other cameras to automatically change their pan, tilt and focus settings.

Moreover, the imaging system according to the invention further has means for producing frame images of the sides of the object from the images taken by the plurality of imaging devices.

Also, the imaging system according to the invention further has means for identifying the object, such as image recognition means or sensors, so that, when the object moves around within a certain area, the position of the object can be detected.

In addition, the imaging system according to the invention still further has means for transmitting the images taken by the plurality of imaging devices to a dedicated display apparatus.

Thus, according to the construction of the invention, even when the object moves around, the same object can be captured from a plurality of directions at a time by the imaging devices that are arranged to surround the object and moved in association with each other.

In addition, it is possible to easily produce the images that are displayed on a dedicated display apparatus capable of displaying images so that the user can view the images from all directions.

Other objects, features and advantages of the invention will become apparent from the following description of the embodiments of the invention taken in conjunction with the accompanying drawings.

### BRIEF DESCRIPTION OF THE DRAWINGS

FIG. 1 is a perspective outline view of an imaging system of the first embodiment.

FIG. 2 is a plan view of the imaging system of the first embodiment, showing the directions in which the imaging devices take a picture.

FIG. 3 shows images that can be captured from the imaging directions shown in FIG. 2.

FIG. 4 is a diagram showing the components of main parts of the imaging system of the first embodiment.

FIG. 5 is a diagram schematically showing the whole construction of the imaging system of the first embodiment.

FIG. 6 is a diagram showing the components of main parts of another imaging system of the first embodiment.

FIG. 7 is a diagram schematically showing the whole construction of the other imaging system of the first embodiment.

FIG. 8 is a perspective outline view of an imaging system of the second embodiment.

FIG. 9 is a diagram showing the components of main parts of the imaging system of the second embodiment.

FIG. 10 is a diagram schematically showing the whole construction of the imaging system of the second embodiment.

FIG. 11 is a perspective outline view of an imaging system of the third embodiment.

FIG. 12 is a perspective outline view of the first display apparatus according to the fourth embodiment.

FIG. 13 is a diagram showing the images that are transmitted from the imaging system to the display apparatus of the fourth embodiment.

FIG. 14 is a perspective outline view of the second display apparatus according to the fourth embodiment.

FIG. 15 is a diagram showing the images to be projected in the second display apparatus according to the fourth embodiment.

### DESCRIPTION OF THE EMBODIMENTS

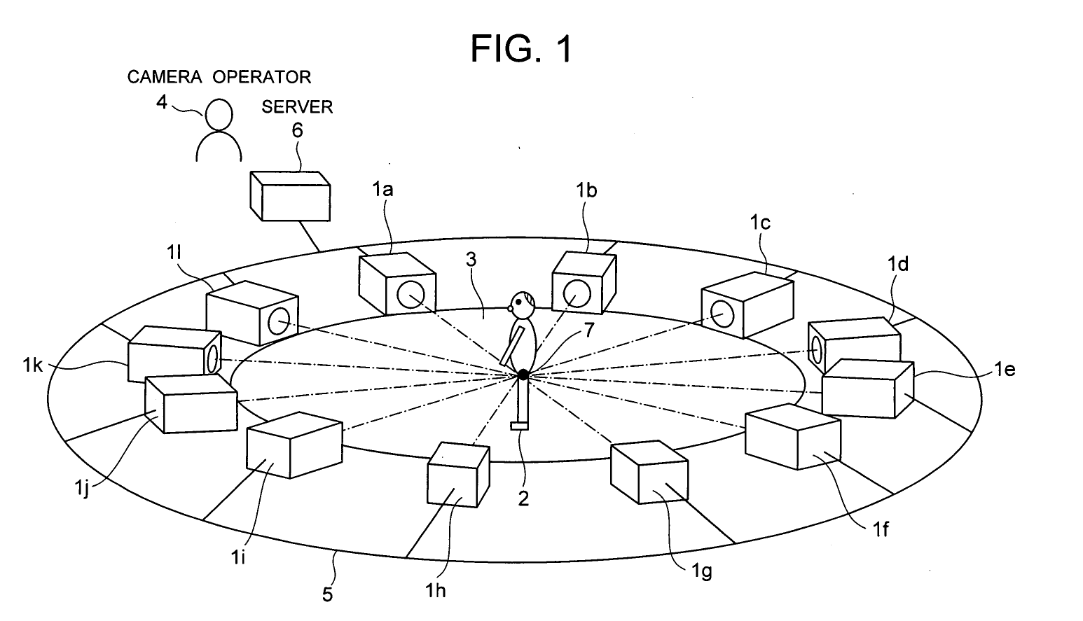

Embodiments of the invention will be described in detail with reference to FIGS. 1 through 13.

### Embodiment 1

The first embodiment of the invention will be first described with reference to FIGS. 1 through 5. This embodiment is an imaging system for imaging a moving object while it is being tracked, and transmitting the captured image to a dedicated three-dimensional display apparatus. FIG. 1 is a perspective outline view of the imaging system of this embodiment according to the invention. Referring to FIG. 1, there are shown CCD cameras 1a through 1l, an object 2 (to be captured), an area 3 within which the object 2 moves around, a camera operator 4, and a server 6 for controlling the cameras.

As illustrated, the CCD cameras 1a through 1l are provided to surround the area 3 within which the object 2 moves around. The CCD cameras 1a through 1l are respectively located at fixed positions, and connected through a communication path 5 to the server 6. The pan, tilt and zoom of each of the CCD cameras 1a through 1l are controlled by a controller of the server 6.

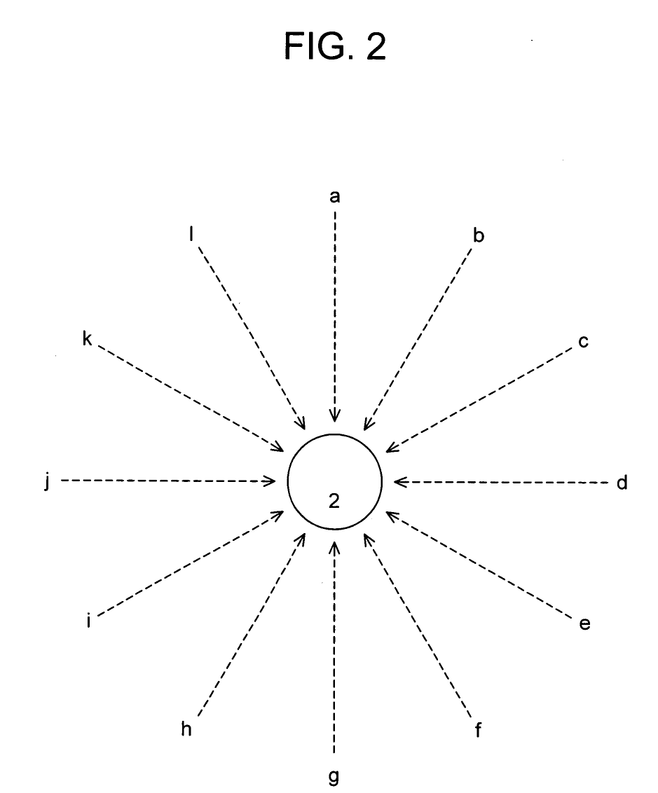

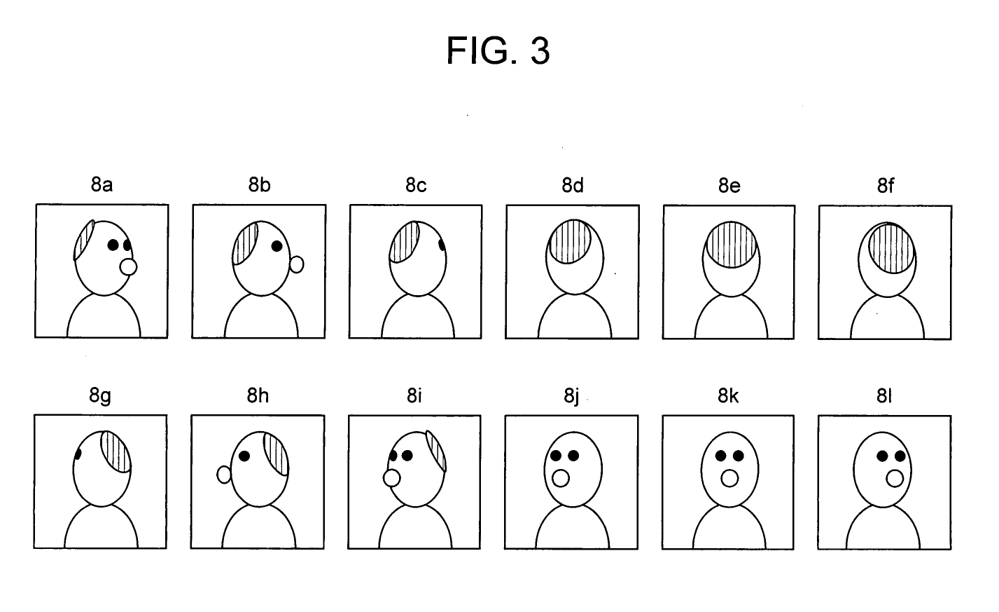

It is assumed that the effective area 3 within which the object 2 can be captured is at least the screen area of any one of the CCD cameras 1a through 1l that includes the image of object 2. The CCD cameras 1a through 1l respectively capture the image of the object 2 from the directions a through 1 shown in FIG. 2 so as to produce picture frames as, for example, indicated by 8a through 8l in FIG. 3. The images produced from the CCD cameras 1a through 1l may be still or moving pictures.

The communication path 5 may be wired or wireless. The pictures produced from the CCD cameras 1a through 1l may be stored in the memory provided within each CCD camera or in other storage media, but transmitted through a network. In this case, the pictures may be transmitted as data of a digital video format such as MPEG.

The object 2 can freely move within the area 3 in which at least any one of the CCD cameras 1a through 1l can capture the object 2. In this case, the operator 4 handles a one CCD camera (for example, 1a) to track the object 2 and controls it to bring the image of object 2 within its screen or desirably at the center of the angular field of view of the camera.

At that time, the settings of pan, tilt and zoom of the CCD camera 1a handled by the operator 4 are transmitted to the server 6. In the server 6, a three-dimensional position 7 of the object 2 that the CCD camera 1a is picking up can be determined on the basis of the pan, tilt and focus settings of CCD camera 1a. The sever 6 also estimates the pan, tilt and focus settings of each of the other cameras 1b through 1l except camera 1a and sends those values through the communication path 5 to each CCD camera so that the image of object 2 at the position 7 can be brought to the centers of the angular fields of view of the cameras. The CCD cameras 1b through 1l operate to fix their settings of pan, tilt and focus according to the instructions received from the server 6.

At this time, under the condition that the CCD cameras 1a through 1l capture the object with the zoom settings not changed but always kept constant, if the cameras are respectively separated equal distance from the object 2 when the object 2 is at the center of the area 3, the images of object in the images 8a through 8l captured by the CCD cameras 1a through 1l are substantially of equal size. However, if the object 2 is not at the center of the area 3 but away from the center, the sizes of object 2 in the images 8a through 8l are different. That is, the closer any one of the CCD cameras is to the object 2, the larger the size of the object image, or the farther any one of the CCD cameras is from the object 2, the smaller the size of the object image. In this case, the control information to be transmitted from the server 6 to the client of each CCD camera does not need to include the focus settings.

The server 6 can instruct all the CCD cameras 1a through 1l to keep their zoom settings constant, and to change their zoom settings according to the distances from each camera to the position 7 of the object so that the sizes of the object image in the images 8a through 8l captured by the CCD cameras 1a through 1l can be kept equal even if the object moves around within the area 3.

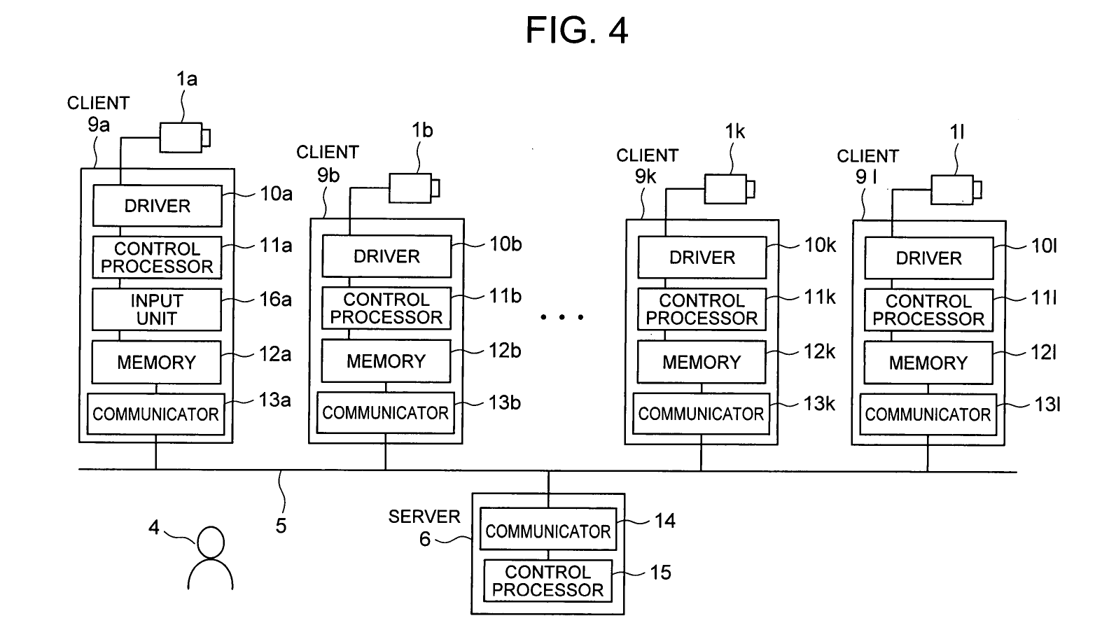

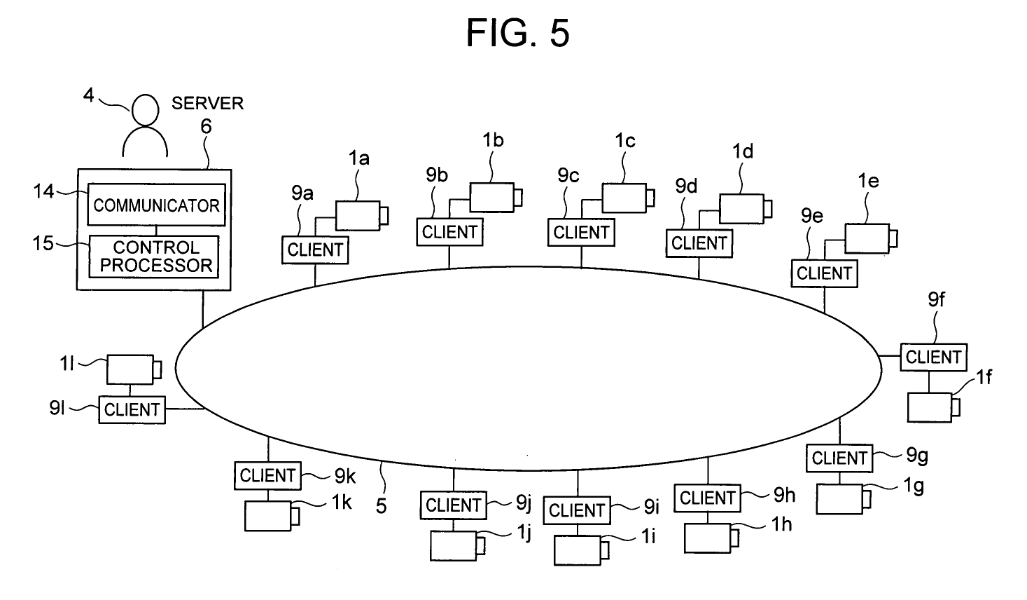

FIG. 4 is a block diagram showing the construction of the first embodiment of the imaging system according to the invention. FIG. 5 is a diagram schematically showing the whole construction of the first embodiment of the imaging system according to the invention. In FIGS. 4 and 5, like elements corresponding to those in FIG. 1 are identified by the same reference numerals.

The CCD cameras 1a through 1l are connected to clients 9a through 9l, respectively. The communicators, 13a through 13l, of the clients 9a through 9l are connected through the communication path 5 to the communicator, 14, of the server 6 so that the pan, tilt and focus settings of the cameras can be transmitted or received between the server 6 and the clients 9a through 9l. In addition, the clients 9a through 9l, respectively, have control processors 11a through 11l for controlling the motion of the corresponding camera on the basis of the received settings, memories 12a through 12l for storing the corresponding settings and captured images, and drivers 10a through 10l for moving their cameras on the basis of the settings. The camera that is directly handled by the operator also has an input unit 16 through which the operator can enter data. The input unit has a user input device including a joystick or various kinds of dials and operation buttons or an interface through which the settings of pan, tilt and focus can be read out when the operator directly adjusts the camera itself to determine the attitude and focus, and an output device from which the pan, tilt and focus settings are transmitted through the communicator 13 to the server 6. This input unit 16 may be provided in all the CCD cameras so that the operator can handle even any camera or in another apparatus (for example, server 6) that is connected through the communication path 5 so that any one of the cameras can be remotely controlled.

In addition, the server 6 has a control processor 15 provided to generate various command signals including the camera settings in accordance with the operation of the input unit. The communicator, 14, of the server 6 is used to transmit or receive the pan, tilt and focus settings to or from each camera. The control processors 11a through 11l of the clients 9a through 9l are connected to the imaging devices or CCD cameras 1a through 1l, respectively. These imaging devices 1a through 1l are disposed as illustrated in FIG. 1.

If, now, the operator 4 operates the input unit to enter pan, tilt and focus values for a certain imaging device (for example, CCD camera 1a), the contents of this operation are transmitted to the control processor 11a. This information is also transmitted through the communicator 13a to the control processor 15 of the server 6, where the pan, tilt and focus settings of each CCD camera 1b through 1l except CCD camera 1a can be estimated by a signal processor not shown of the server 6. The estimated settings are transmitted to the control processors 11b˜11l from the communicator 14 of the server 6 via the communication path 5 and the communicators 13b˜13l of the clients 9b˜9l. In addition, the drivers 10b˜10l drive the CCD cameras 1b˜1l, respectively. The captured images from the CCD cameras 1a˜1l are stored in the memories 12a˜12l of the clients 9a˜9l. At this time, the operator 4 is able to remotely control the cameras through the server 6.

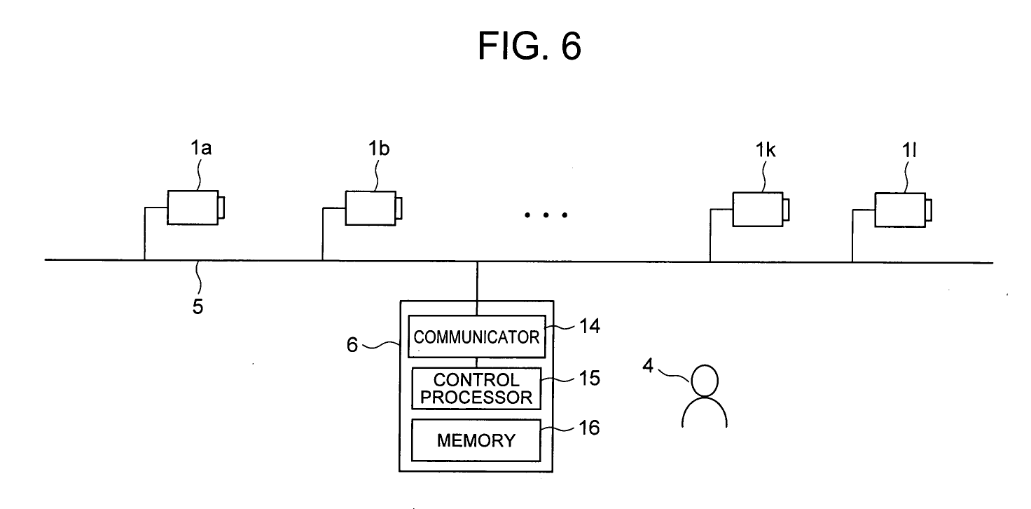

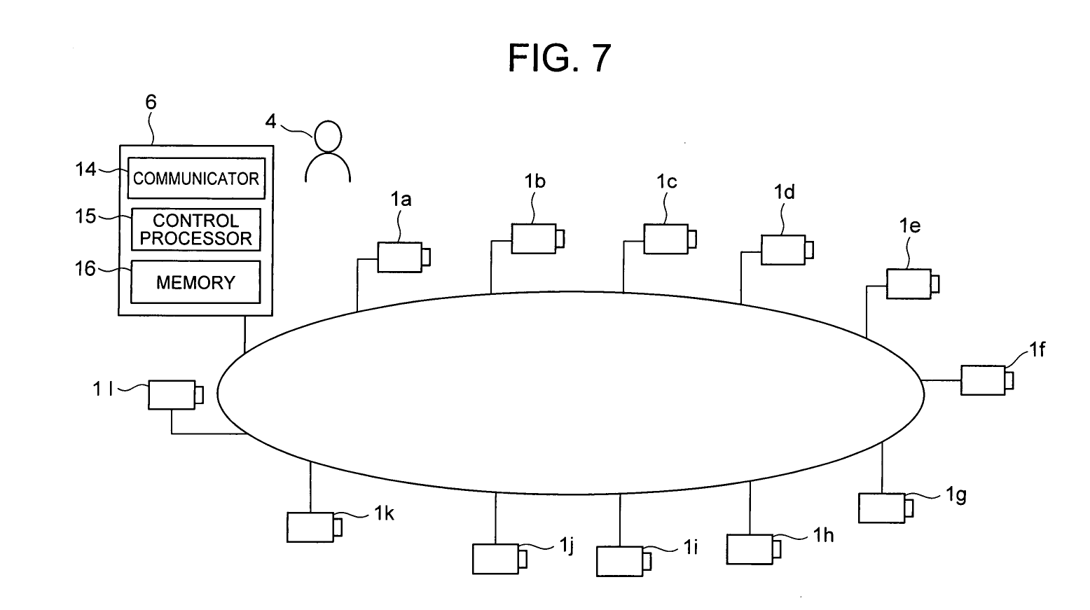

FIG. 6 is a diagram showing the components of main parts of another imaging system of the first embodiment. FIG. 7 is a diagram schematically showing the whole construction of the other imaging system of the first embodiment. In FIGS. 6 and 7, like elements corresponding to those in FIGS. 1 and 4 are identified by the same reference numerals.

The CCD cameras 1a˜1l are network cameras directly connected to the communication path 5. The communicator 14 of the server 6 is also connected to the communication path 5. The server 6 also has the control processor 15 and a memory 16 provided as means for controlling the pan, tilt and focus driving mechanisms of each of the CCD cameras 1a˜1l through the network.

If, now, the operator 4 operates operation means not shown to control a certain imaging device (for example, CCD camera 1a) about pan, tilt and focus, the control processor 15 of the server 6 processes the details of this operation, and estimates theoretical values of pan, tilt and focus of the remaining CCD cameras 1b˜1l. Those settings are transmitted via the communicator 14 of server 6 to the CCD cameras 1b˜1l, which are then driven by their drivers not shown. The images from the CCD cameras 1a˜1l are sent via the communication path 5 to and stored in the memory 16 of server 6. At this time, the operator 4 is also able to remotely control the cameras through the server 6.

In this embodiment, since the remaining cameras are automatically controlled in response to the operation that the operator 4 makes, the operator 4 needs to handle only a certain single camera in order that the object 2 on which his eyes are kept can be captured from a plurality of directions. In addition, the operator 4 can handle any CCD camera. For example, as the object moves, the operator 4 can select a camera facing the front of the object 2 by witching, and operate it.

### Embodiment 2

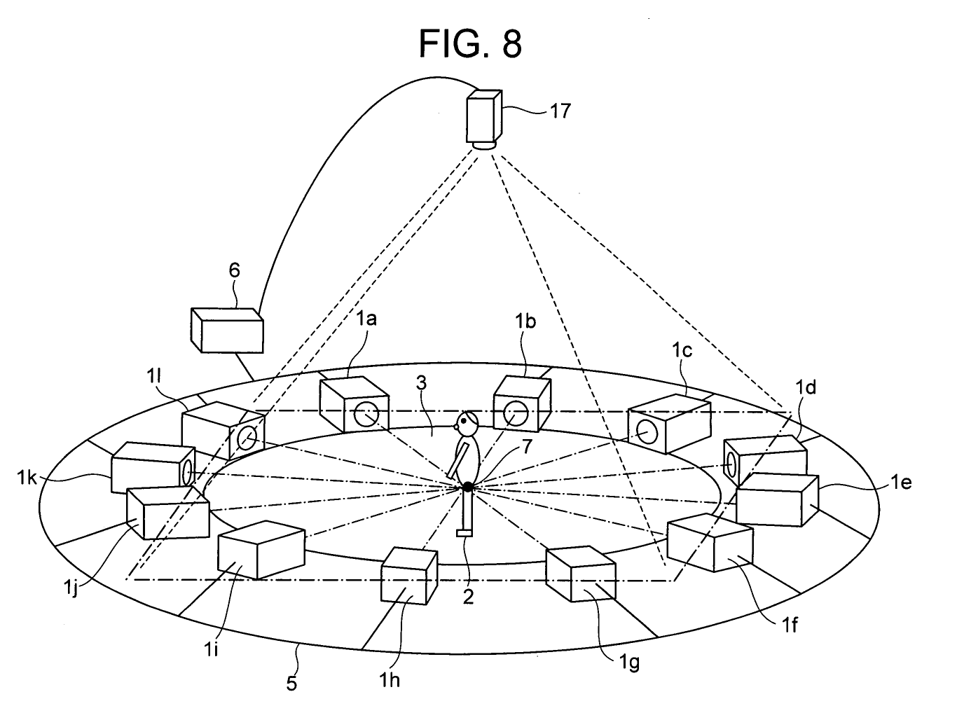

The second embodiment of the imaging system according to the invention will be described with reference to FIGS. 8 through 12. FIG. 8 is a perspective view showing the outline of the second embodiment of the imaging system according to the invention. Referring to FIG. 8, there are shown the CCD cameras 1a through 1l, the object 2 (to be captured), the area 3 within which the object 2 moves around, the controller (server) 6 of this imaging system, and a reference camera 17 to capture the whole of area 3 within which the object 2 moves around. This camera 17 is desired to install directly over the intersection of the central perpendicular axes across the plane of area 3 because it is used to detect the position of object 2 within the area 3.

As illustrated, the CCD cameras 1a˜1l are provided to surround the area 3 within which the object 2 moves in the same way as in FIG. 1. The CCD cameras 1a˜1l are fixed at predetermined positions, and connected together through the communication path 5. The controller of server 6 controls the pan, tilt and zoom mechanisms of the CCD cameras 1a˜1l.

Any one of the CCD cameras 1a˜1l can capture the object 2 that freely moves around within the area 3. It is assumed that the reference camera 17 is disposed at a position where it can capture the whole area 3 at a time within which the object 2 moves around, and has an angular field of view enough to take a picture of area 3. The picture taken by the reference camera 17 is converted to the NTSC signal system or the like and it is fed to the server 6 or may be supplied via the communication path 5 to the server 6. At this time, the server 6 can use the image recognition technology to track the position of the object 2 that moves around within the image 3 displayed on the screen of the reference camera 17. Thus, the pan, tilt and focus settings of CCD cameras 1a˜1l can be estimated on the basis of the position of object 2 tracked as above.

At this time, if the CCD cameras 1a˜1l take a picture with the zoom kept constant without changing the zoom settings in the same way as in the first embodiment, they have substantially an equal size of object 2 taken on their screens to appear in the images 8a˜8l in the case where the cameras are each separated approximately an equal distance from the object 2 that is at the center of area 3. However, in the case where the object 2 is located away from the center of area 3, the sizes of object 2 appearing in the images 8a˜8l captured by the CCD cameras 1a˜1l become different. That is, the closer the cameras are to the object 2, the larger the sizes of object 2, but the farther the cameras are from the object 2, the smaller the sizes of object 2.

The server 6 is able to command all the CCD cameras 1a˜1l to keep their zoom settings constant, and to change the zoom settings so that the sizes of the object 2 appearing in the images 8a˜8l taken by the cameras can be equal even when the object 2 moves to any point within the area 3.

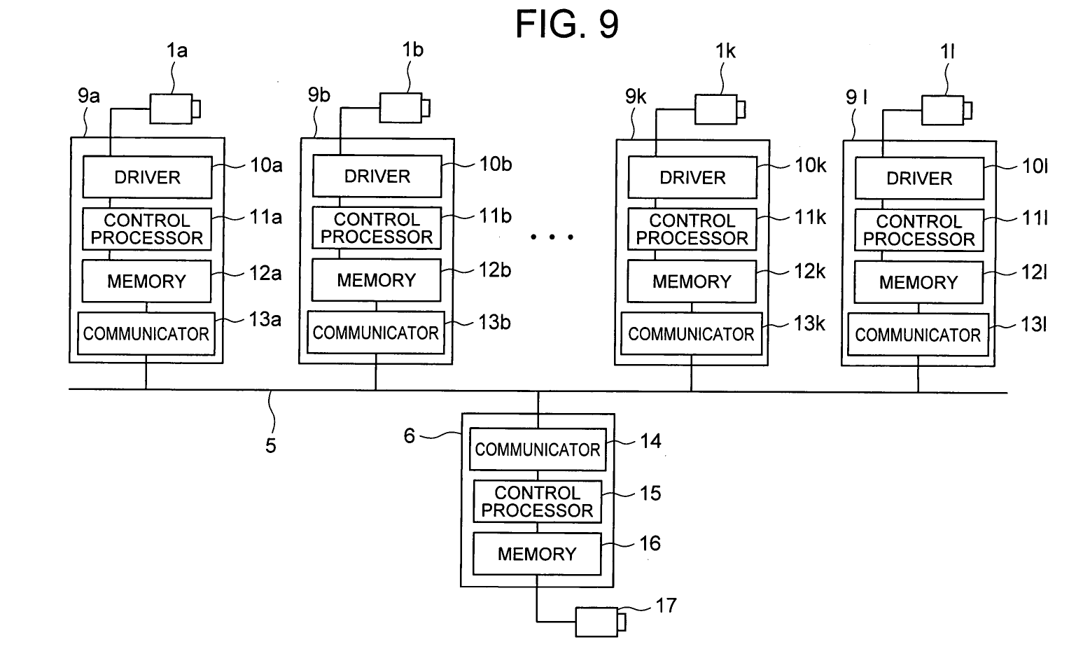

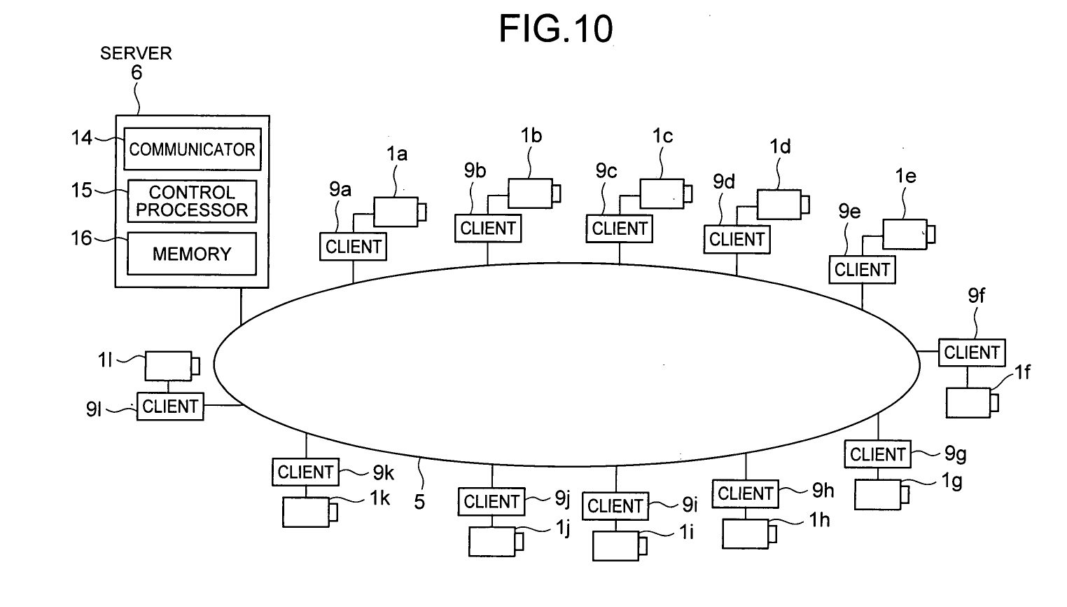

FIG. 9 is a block diagram showing the construction of main parts of the second embodiment of the imaging system according to the invention. FIG. 10 is a diagram schematically showing the whole construction of the second embodiment of the imaging system according to the invention. In FIGS. 9 and 10, like elements corresponding to those in FIG. 8 are identified by the same reference numerals.

The CCD cameras 1a˜1l are connected to the clients 9a˜9l. The communicators 13a˜13l of the clients 9a˜9l are connected through the communication path 5 to the communicator 14 of the server 6. The clients 9a˜9l also have control processors 11a˜11l, memories 12a˜12l and drivers 10a˜10l, respectively. In addition, the server 6 has the control processor 15 provided to generate various kinds of command signals in accordance with the operation of an operation unit not shown. Here, the imaging devices 1a˜1l are connected to the control processors 11a˜11l of clients 9a˜9l. These imaging devices 1a˜1l are disposed in the same way as described with reference to FIG. 1.

The object 2 to be tracked is previously set on the image captured by the reference camera 17. The reference camera 17 takes a picture directly from above the object 2 at any time, and the position of the object 2 within the area 3 can be detected from the image taken by the camera 17. In addition, the motion of object 2 can be tracked by computing the difference between the images taken one after another at intervals of a time unit. However, the two-dimensional position of object 2 is determined from the images taken by this reference camera 17. When the object 2 moves on the same plane, the vertical position of object 2 is previously measured when the object 2 is captured, and the CCD cameras 1a˜1l are controlled on the basis of this position. When the object 2 moves in the vertical direction, means for detecting the height, such as a position sensor, is carried on the object 2, and the detected information is transmitted to the server 6.

In this case, an RFID tag or the like can be bonded to the object 2 as the means for detecting the position of object 2 not only to detect the position but also to discriminate a plurality of persons within the area. The floor may be all made of a force plate or the like so that the position of the object 2 can be recognized from the position of the load applied by the object 2. Means of GPS and acceleration sensor can also be used. In addition, the top of the head or shoulder of object 2 may be marked with a fluorescent paint so that the paint can be seen from above and that the reference camera 17 can track the object 2 by detecting the mark. In that case, if such paint is coated on a plurality of places such as both shoulders of object 2, the orientation, or attitude of object 2 can also be detected with ease.

In the second embodiment of the imaging system according to the invention, by only previously coating a mark or attaching a sensor on the object 2 it is possible to fully automatically track, capture and record the motion of object 2 without being aided by the operator.

### Embodiment 3

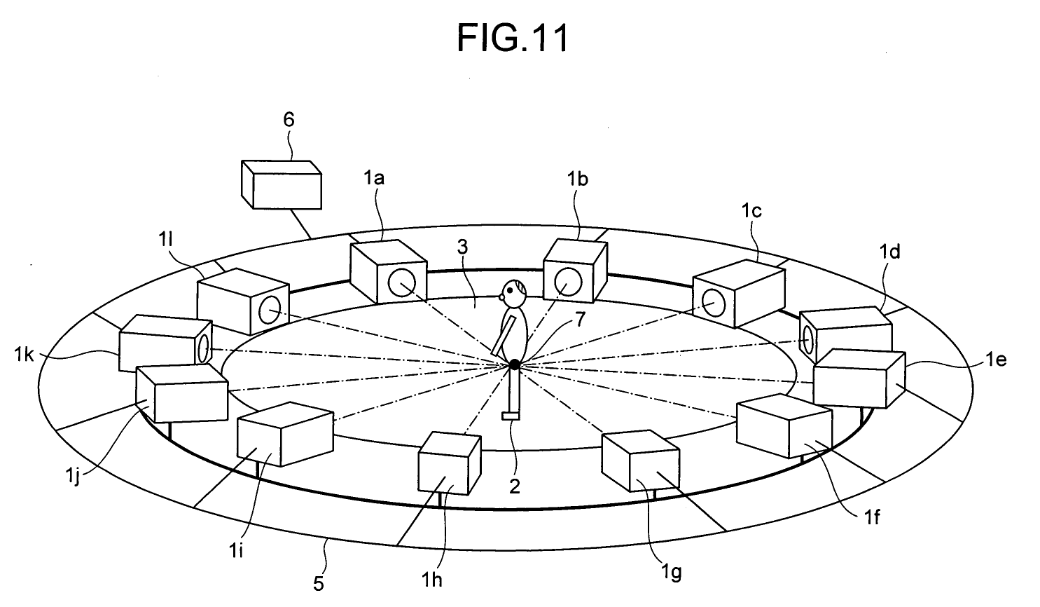

The third embodiment of the imaging system according to the invention will be described with reference to FIG. 11. FIG. 11 is a perspective view showing the outline of the third embodiment of the imaging system according to the invention. Referring to FIG. 11, there are shown CCD cameras 1a˜1l, the object 2 (to be captured), the area 3 within which the object 2 moves around, the controller (server) 6 of this imaging system, and a circular or elliptic rail along which the CCD cameras 1a˜1l can move.

The CCD cameras 1a˜1l are mounted on the rail 18 to surround the area 3 within which the object 2 moves around in the same way as in FIG. 1. The CCD cameras 1a˜1l can move to any position on the rail 18, and they are connected together through the communication path 5. The controller of server 6 controls the pan, tilt and zoom mechanisms of the CCD cameras 1a˜1l.

While the method for recognizing the position of object 2 and controlling the CCD cameras 1a˜1l in the third embodiment is the same as that described in the sections of the first and second embodiments, more ones of the CCD cameras 1a˜1l can be collected to face the front of the object 2 in the third embodiment. In order to detect the front of the object 2, it can be considered to provide beacon transmitters or markers attached to both sides of the object 2 if the object 2 is wide as described in the section of embodiment 2, and to have sensor means provided at a position to surround the area 3 to detect the beacons and markers. In addition, when the object 2 moves around within the area 3, more ones of the CCD cameras can be collected to the direction in which the object 2 has moved. Therefore, many cameras can be gathered in the more desired direction so as to capture the object 2 more precisely in different directions at a time.

### Embodiment 4

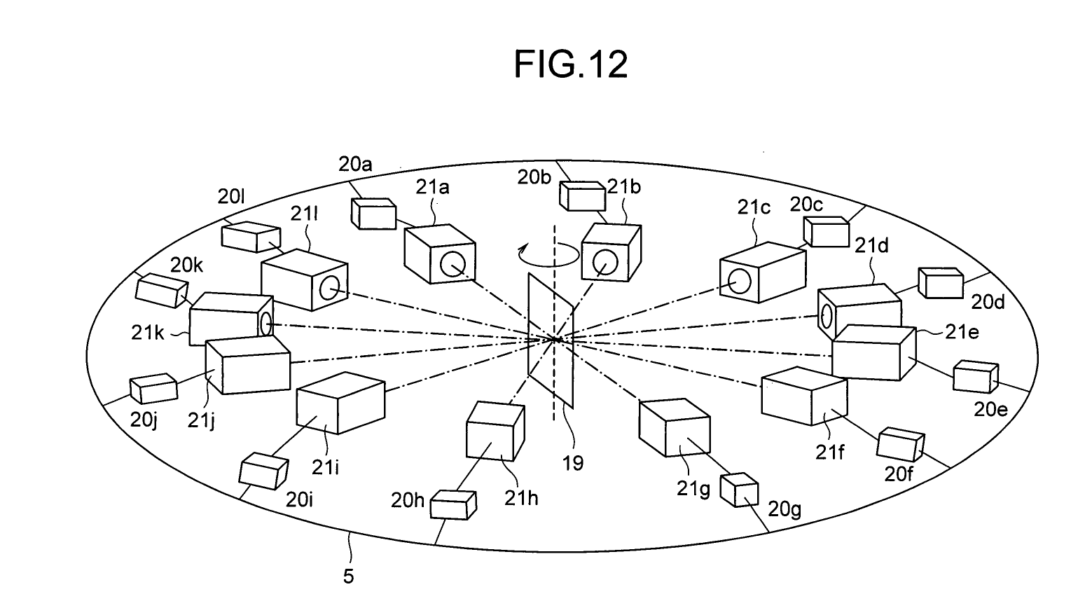

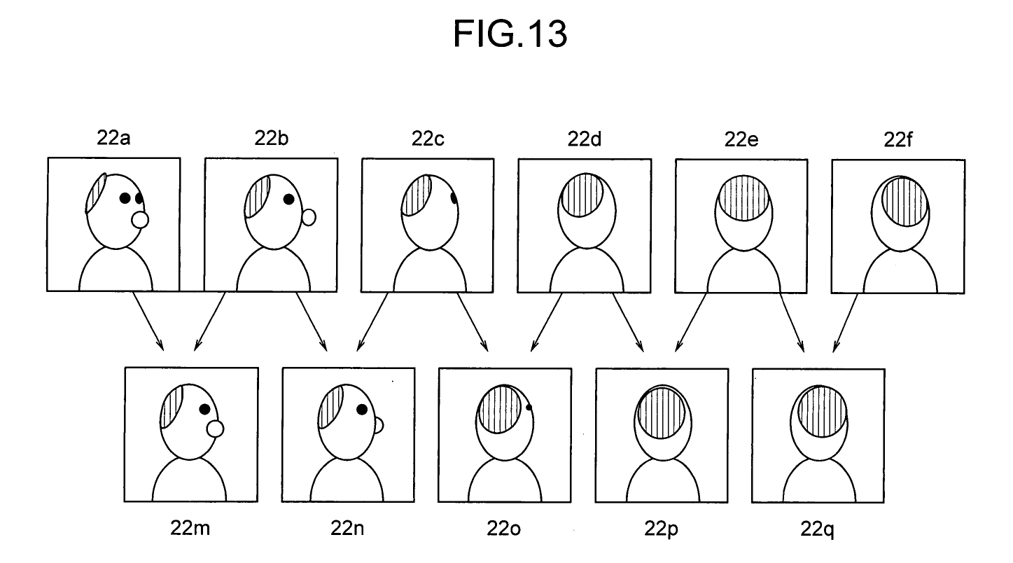

A description will be made of an embodiment of the method for transmitting the images from the imaging system according to the invention to a dedicated 3-D display apparatus with reference to FIGS. 12 and 13. FIG. 12 is a perspective view showing the outline of a dedicated display apparatus for displaying the images taken by the imaging system according to the invention. The construction of this display apparatus is described in detail in U.S. patent application Publication No. 2004/0196362 and U.S. Ser. No. 10/928,196 filed on Aug. 30, 2004, that were previously filed by the same applicant. The images of the object 2 captured by the CCD cameras 1a˜1l of the imaging system, which are frames of image of object 2 viewed from a plurality of directions as shown in FIG. 3, are transmitted through the communication path 5 to the clients, 20a˜20l of the display apparatus. The clients 20a˜20l supply the images to projectors 21a 21l, respectively. The display apparatus has at its center a screen 19 kept rotating that has directivity for the reflection of light in the horizontal direction so that the image projected from the projector 21a, for example, can be seen from around the direction in which the projector 21a faces the screen.

At this time, when the CCD cameras 1a˜1l mounted on the imaging system track the object 2 and produce the captured images, and when the projectors 21a˜21l of the display apparatus according to this embodiment project these images, the image of the object 2 can be seen in different directions in which the object 2 has been captured at different angles. In other words, the 3-D image of object 2 can be reproduced.

In this embodiment, even if the imaging system and the display apparatus are separately installed in remote places, the images taken by the imaging system can be transmitted in real time through a network to the display apparatus.

Also, in this embodiment, the number of CCD cameras provided on the imaging system side is not necessary to coincide with that of the projectors on the display apparatus side. When the number of CCD cameras on the imaging system side is larger than that of projectors on the display apparatus side, a predetermined number of images are selected from all the captured images and supplied to the projectors after considering the installation locations and number of the projectors. On the contrary, when the number of CCD cameras on the imaging system side is smaller than that of projectors on the display apparatus side, CG technology such as view morphing can be used to produce intermediate images 22m˜22q from the image frames 22a˜22f captured by the CCD cameras as shown in FIG. 13. In this case, the projectors 21a, 21b, 21c, 21d . . . of the display apparatus project the frame images 22a, 22m, 22b, 22n . . . arranged in this order.

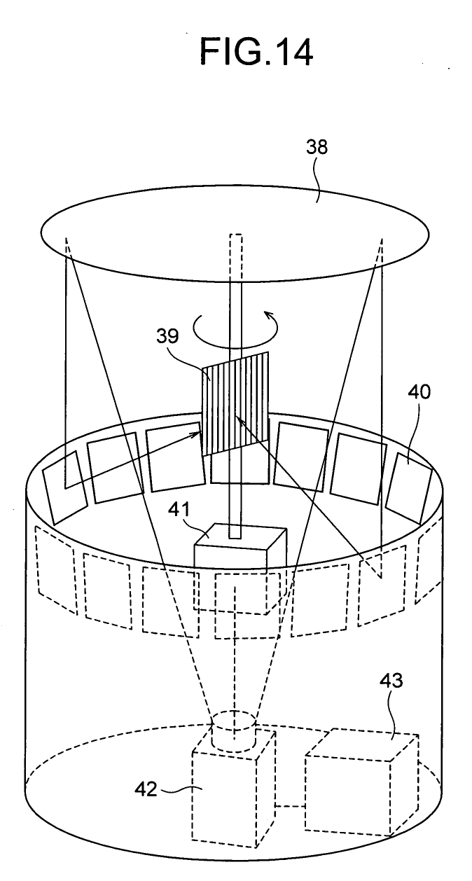

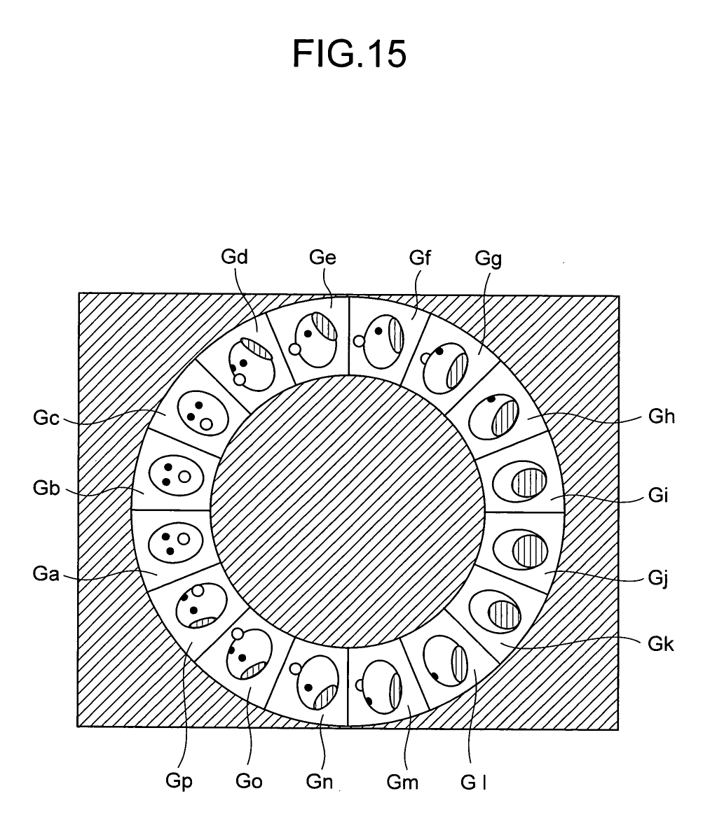

Moreover, even if a single projector is provided on the display apparatus side, a group of mirrors is used so that the frame images can be projected from the surrounding area of the screen as described in the above-given U.S. patent application Publication No. 2004/0196362 and U.S. Ser. No. 10/928,196 filed on Aug. 30, 2004, thus making it possible to decrease the number of projectors. As illustrated in FIG. 14, a projector 42 is provided on an extension of the rotation axis of the screen, and a mirror group 40 is provided along a conical surface that surrounds the screen so that the frame images captured by the CCD cameras on the imaging system side can be projected from the projector, reflected from a top mirror plate 38 and mirror group 40 and then projected from the mirror group. At this time, when the frame images are projected from the projector through the mirror group onto the screen, these frame images are projected from the projector as images arranged in a ring shape so that the frame images captured substantially at the same time can meet the arrangement of the mirror group on the display apparatus (see FIG. 15).

In this embodiment, when the CCD cameras 1a˜1l of the imaging system, of which the zoom values are all kept equal, are picking up the object 2, the viewer's feeling of distance of the captured images on the screen reflects the actual distances from the object 2 to the CCD cameras. Therefore, when the images of object 2 are reproduced on the display apparatus, the object 2 looks large or small depending on the viewing position of the viewer. In other words, when the image taken by the CCD camera close to the object 2 is projected on the screen, the user viewing at the projector feels that the projected image of object 2 looks large. On the contrary, when the image taken by the CCD camera distant from the object 2 is projected on the screen, the user viewing at the projector feels that the projected image of object 2 looks small. Therefore, this case gives the viewer such realistic sensations that the motion of object 2 can be seen as if it were actually moving around near the display apparatus that surround the object 2 because the actual position of the object 2 within the area 3 can be reproduced even on the display apparatus side.

Also, in this embodiment, when the CCD cameras 1a˜1l of the imaging system are taking a picture of object 2 with their zoom values changed considering the distances of the cameras to the object 2, the images of object 2 captured by the CCD cameras 1a˜1l can all be made equal in size by adjusting the angular field of view. At this time, even when the images of the object 2 reproduced on the display apparatus are viewed from all the directions, they can be perceived to be exactly equal in size with the size not changed depending upon the viewing position of the viewer. However, since the area ratios of the images of object 2 included in the angular fields of view of the CCD cameras to the angular fields of view depend upon the distances from the CCD cameras to the object 2, the resolutions of the images of object 2 captured by the CCD cameras are not equal.

Therefore, in this case, the images of object 2 reproduced on the display apparatus have slightly different resolutions depending upon the direction in which the user views, but they look equal in size even when viewed in all the directions. Thus, this case gives the viewer such effect that the viewer feels as if he or she were always moving to run after the moving object 2.

The above effect that can be achieved by using different zoom settings in the CCD cameras 1a˜1l of the imaging system can also be selected on the display apparatus side. That is, the CCD cameras 1a˜1l of the imaging system take a picture with the angular field of view always made as wide as possible, and transmit the taken images to the clients of the display apparatus. When it is desired that the images of the object are made different in size depending upon the direction in which the user views, the captured images can be processed by trimming or the like on the clients of the display apparatus and then supplied to the projector.

In addition, the rotating screen can be replaced by a screen of substantially cylindrical shape or elliptical cylinder shape having means for limiting the field angle.

It should be further understood by those skilled in the art that although the foregoing description has been made on embodiments of the invention, the invention is not limited thereto and various changes and modifications may be made without departing from the spirit of the invention and the scope of the appended claims.

1. An imaging system comprising:
a plurality of imaging devices arranged to surround an imaging area in which an object whose image is to be captured is placed and to take a picture of said object from different directions; and
a server connected through a communication path to said plurality of imaging devices,
said server being configured to control the attitudes of said plurality of imaging devices as said object moves around.

2. An imaging system according to claim 1, wherein said server detects the position of said object, determines the attitudes of the respective imaging devices on the basis of said position, and commands the respective imaging devices to adopt said attitudes.

3. An imaging system according to claim 1, wherein said server receives the pan, tilt and focus settings of a certain one of said imaging devices, and controls the attitudes of the remaining imaging devices on the basis of said pan, tilt and focus settings of said certain one of said imaging devices.

4. An imaging system according to claim 1, further comprising a reference camera of which the angular field of view covers the whole of said imaging area, and that is connected to said server, wherein said server detects the position of said object by using the image produced from said reference camera, and controls the attitudes of said plurality of imaging devices on the basis of said position.

5. An imaging system according to claim 1, wherein the attitudes that said server commands said imaging devices to adopt are values of pan and tilt or values of pan, tilt and focus of said imaging devices.

6. An imaging system according to claim 1, further comprising means for producing frames of image that represent the images of the sides of said object by using the images taken by said plurality of imaging devices.

7. An imaging system according to claim 6, wherein said server generates an intermediate image between two frames of image by the view morphing using said two frames of image produced from two adjacent ones of said plurality of imaging devices.

8. An imaging system according to claim 1, wherein said imaging devices each have a memory for storing their captured image.

9. An imaging system according to claim 1, wherein the images produced from said plurality of imaging devices are used to generate a three-dimensional image when said images are projected on a screen from a plurality of directions that surround said screen.

10. An imaging method using a plurality of imaging devices arranged to surround an imaging area in which an object whose image is to be captured is placed, and to capture said object from different directions, and a server connected through a communication path to said plurality of imaging devices, wherein said server detects the position of said object, determines the attitudes of said plurality of imaging devices on the basis of said position, and notifies said imaging devices of said information of attitudes, so that said imaging devices can be controlled in their attitudes by said information of attitudes to properly capture said object.
